(19) United States
(12) Patent Application Publication
(10) Pub. No.: US 2024/0169604 A1
(43) Pub. Date: May 23, 2024

(54) TEXT AND COLOR-GUIDED LAYOUT CONTROL WITH A DIFFUSION MODEL

(71) Applicant: ADOBE INC., SAN JOSE, CA (US)

(72) Inventors: Yosef Gandelsman, Berkeley, CA (US); Taesung Park, San Francisco, CA (US); Richard Zhang, Burlingame, CA (US); Elya Shechtman, Seattle, WA (US); Alexei A. Efros, Berkeley, CA (US)

(21) Appl. No.: 18/057,453

(22) Filed: Nov. 21, 2022

(51) Int. Cl. G06T 11/00; G06F 3/04842; G06F 3/04845; G06T 11/20

(52) U.S. Cl. CPC G06T 11/001; G06F 3/04842; G06F 3/04845; G06T 11/20

(57) ABSTRACT

Systems and methods for image generation are described. Embodiments of the present disclosure obtain user input that indicates a target color and a semantic label for a region of an image to be generated. The system also generates of obtains a noise map including noise biased towards the target color in the region indicated by the user input. A diffusion model generates the image based on the noise map and the semantic label for the region. The image can include an object in the designated region that is described by the semantic label and that has the target color.

### BACKGROUND

The following relates generally to machine learning, and more specifically to machine learning for image generation. Digital image processing refers to the use of a computer to edit a digital image using an algorithm or a processing network. In some cases, image processing software can be used for various image processing tasks, such as image editing, image restoration, image generation, etc. Some image processing systems may implement machine learning techniques, for example, to perform tasks using predictive models (e.g., without explicitly programing the system for each task), to perform tasks with more accuracy or in less time, to perform tasks using special-purpose hardware, etc.

Image generation (a subfield of digital image processing) includes the use of a machine learning model to generate images. Diffusion-based models are one category of machine learning models that can used to generate images. Specifically, diffusion models can be trained to take random noise as input and generate new images with features similar to the training data. In some examples, diffusion models can be used to generate unseen images or inpainted images (i.e., filling missing regions or masked areas).

### SUMMARY

The present disclosure describes systems and methods for image processing. Embodiments of the disclosure include an image generation apparatus configured to receive user input and generate an output image using a diffusion model. The user input indicates a target color and a semantic label for a region of an image to be generated. In some examples, different target colors and semantic labels corresponding to a set of objects are drawn on an image canvas via a custom user interface. A noise version of a color layout is provided as input to a text-guided diffusion model. The text-guided diffusion model includes a perception model that enforces intermediate image outputs to comply with the text prompt (e.g., semantic labels). The image generation apparatus has precise control over the layout of the set of objects in an output image to be generated. Accordingly, the output image is consistent with the intended color layout and the semantic labels.

A method, apparatus, and non-transitory computer readable medium for image generation are described. One or more embodiments of the method, apparatus, and non-transitory computer readable medium include obtaining user input that indicates a target color and a semantic label for a region of an image to be generated; generating a noise map including noise biased towards the target color in the region indicated by the user input; and generating the image based on the noise map and the semantic label for the region using a diffusion model, wherein the image includes an object in the region that is described by the semantic label and that has the target color.

A method, apparatus, and non-transitory computer readable medium for image generation are described. One or more embodiments of the method, apparatus, and non-transitory computer readable medium include obtaining training data including a training image and training layout information that includes semantic information and color information for a region of the training image; initializing parameters of a diffusion model; generating a predicted image using the diffusion model based on the semantic information and the color information; computing a loss function based on the training image and the predicted image; and training the diffusion model by updating the parameters of the diffusion model based on the loss function.

An apparatus and method for image generation are described. One or more embodiments of the apparatus and method include one or more processors; one or more memories including instructions executable by the one or more processors to; obtaining user input that indicates a target color and a semantic label for a region of an image to be generated; generating a noise map including noise biased towards the target color in the region indicated by the user input; and generating the image based on the noise map and the semantic label for the region using a diffusion model, wherein the image includes an object in the region that is described by the semantic label and that has the target color.

### BRIEF DESCRIPTION OF THE DRAWINGS

FIG. 1 shows an example of an image generation system according to aspects of the present disclosure.

FIG. 2 shows an example of an image generation apparatus according to aspects of the present disclosure.

FIG. 3 shows an example of a pixel diffusion model according to aspects of the present disclosure.

FIG. 4 shows an example of a latent diffusion model according to aspects of the present disclosure.

FIG. 5 shows an example of U-net architecture according to aspects of the present disclosure.

FIG. 6 shows an example of image generation according to aspects of the present disclosure.

FIG. 7 shows an example of text to image generation according to aspects of the present disclosure.

FIG. 8 shows an example of a method for operating a user interface according to aspects of the present disclosure.

FIG. 9 shows an example of a user interface according to aspects of the present disclosure.

FIG. 10 shows an example of a method for image generation according to aspects of the present disclosure.

FIG. 11 shows an example of image generation based on color-guided layout according to aspects of the present disclosure.

FIG. 12 shows an example of a method for training a diffusion model according to aspects of the present disclosure.

FIG. 13 shows an example of a method for training a diffusion model according to aspects of the present disclosure.

FIG. 14 shows an example of a computing device according to aspects of the present disclosure.

### DETAILED DESCRIPTION

The present disclosure describes systems and methods for image processing. Embodiments of the disclosure include an image generation apparatus configured to receive user input and generate an output image using a diffusion model. The user input indicates a target color and a semantic label for a region of an image to be generated. In some examples, different target colors and semantic labels corresponding to a set of objects are drawn on an image canvas via a custom user interface. A noise version of a color layout is provided as input to a text-guided diffusion model. The text-guided diffusion model includes a perception model that enforces intermediate image outputs to comply with the text prompt (e.g., semantic labels). The image generation apparatus has precise control over the layout of the set of objects in an output image to be generated. Accordingly, the output image is consistent with the intended color layout and the semantic labels.

Diffusion models are a class of generative neural networks that can be trained to generate new data with features similar to features found in training data. Diffusion models can be used in image completion tasks, such as image inpainting. In some examples, however, diffusion models may generate poor results when taking masked images as a condition for inpainting. Conventional models have not combined text and color input and have not enabled a user interface (e.g., via a virtual brush) to represent color and text information (e.g., semantic labels). For instance, diffusion models may generate unwanted results that are not faithful to the text input and object relations. Additionally, these models cannot control the layout of objects (e.g., location, size, or orientation) in the generated images and thus lack controllability.

Embodiments of the present disclosure include an image generation apparatus including a user interface configured to provide combined color and label guidance for image generation. A noise version of a color layout is provided as input to a text-guided diffusion model. The text-guided diffusion model includes a perception model that enforces intermediate image outputs to comply with the text prompt (e.g., semantic labels). The image generation apparatus is configured to have a precise control over the layout of the set of objects in an output image to be generated. In some examples, the image generation apparatus combines text and color input and enables a user interface (e.g., via a virtual brush) to represent color and text information (e.g., semantic labels).

In some embodiments, the image generation apparatus includes a text-guided diffusion model for image generation. In some examples, the text-guided diffusion model is Guided Language-to-Image Diffusion for Generation and Editing (Glide) model. When denoising a noisy image (e.g., a noisy version of color layout or map), a perception model is configured to determine whether a masked region of the noisy image matches the text prompt (e.g., semantic label or class information). In some examples, the perception model includes a Contrastive Language-Image Pre-Training (CLIP) model. The image generation apparatus back-propagates the model, identifies a differential noise, and modifies the noisy image by adding the differential noise. The image generation apparatus repeats a similar process for intermediate output images. For example, the image generation apparatus modifies intermediate output images at each timestep such that the final output image includes objects that follow the semantic labels. The semantic labels correspond to a set of regions in an image canvas, where the semantic labels are indicated by users.

The image generation apparatus includes using stochastic differential editing (SDEdit) method, which synthesizes realistic images by iteratively denoising through a stochastic differential equation (SDE). Given an input image with user guide in a form of manipulating RGB pixels, SDEdit first adds noise to the input image, then subsequently denoises the resulting image (or intermediate output image) through the SDE prior to increasing its realism.

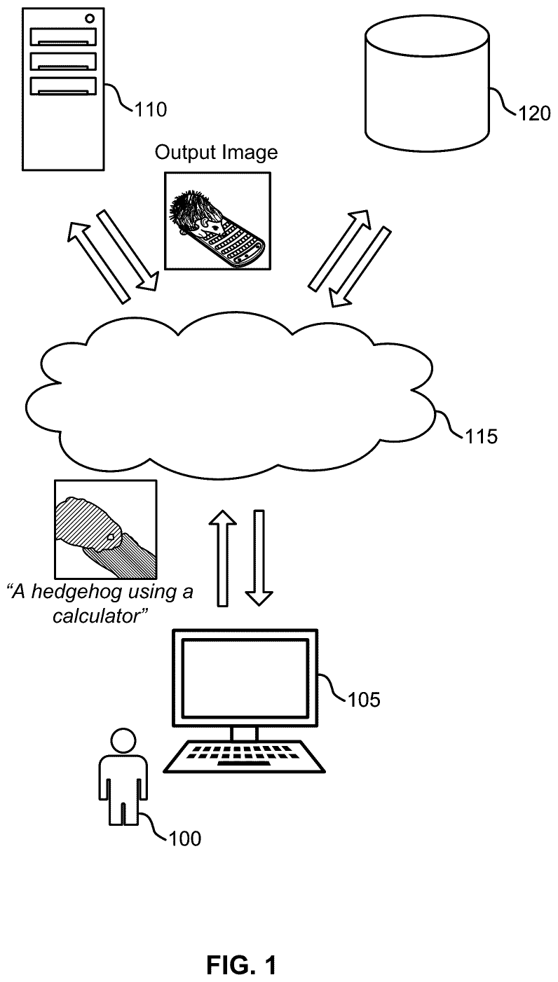

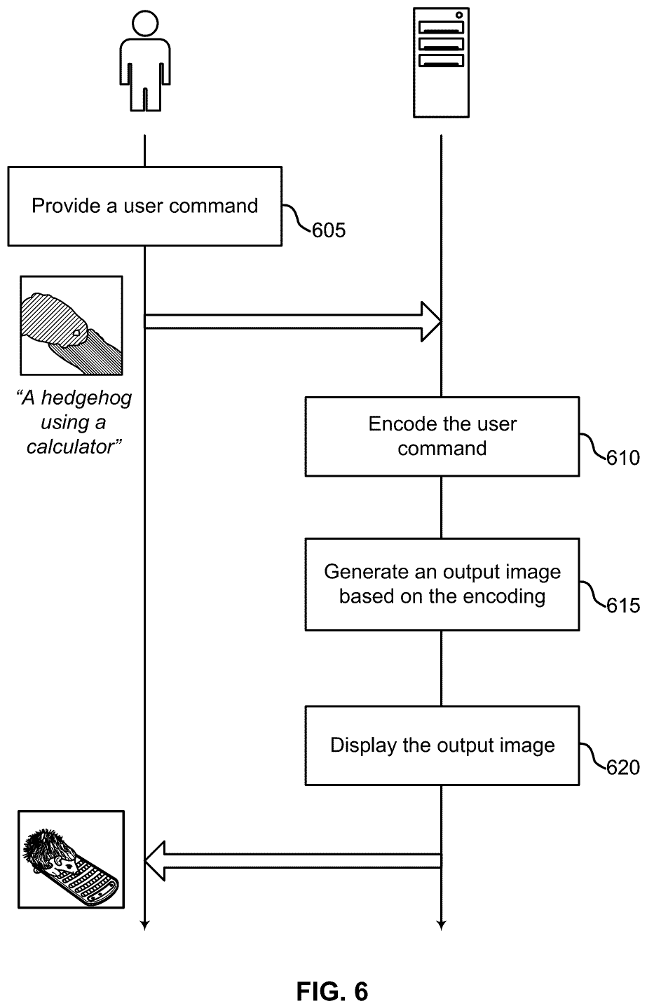

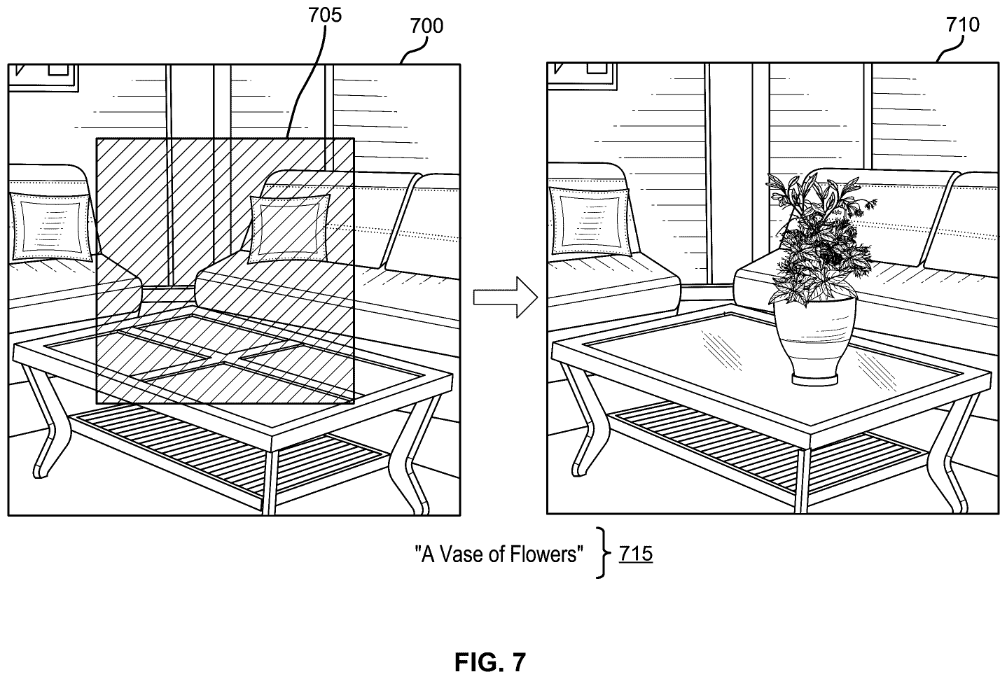

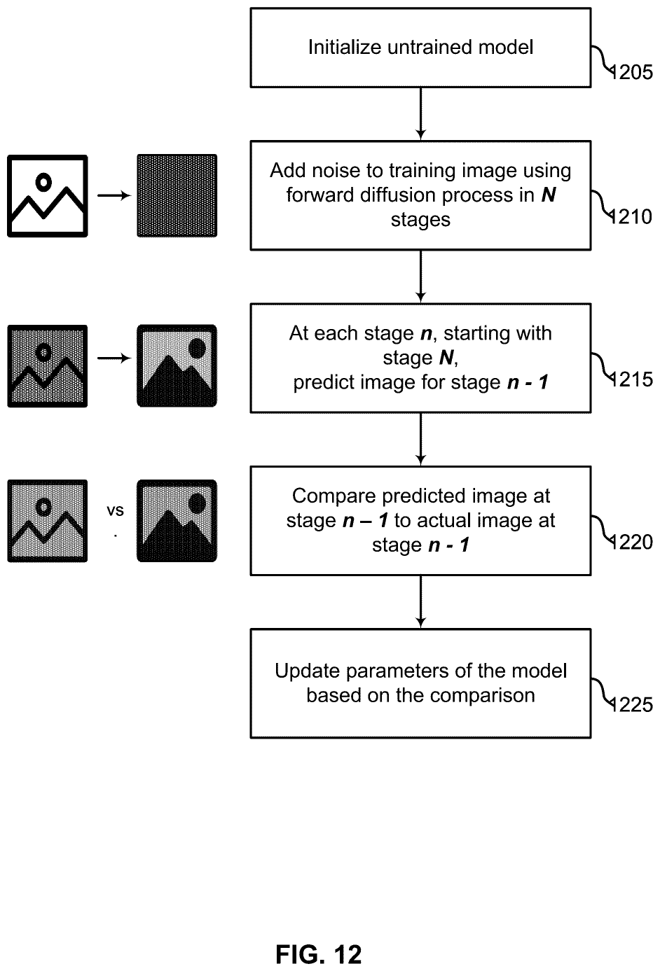

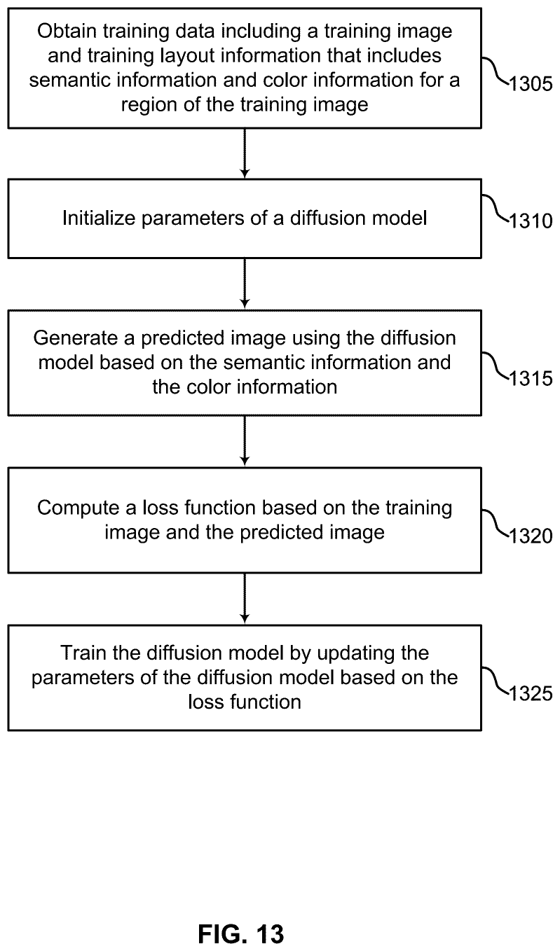

Embodiments of the present disclosure can be used in the context of image generation applications. For example, an image generation apparatus based on the present disclosure receives user input via the user interface including text input, color input, and selection region input and generates a realistic image based on the user input. An example application in the image generation processing context is provided with reference to FIGS. 6-7. Details regarding the architecture of an example image generation system are provided with reference to FIGS. 1-5 and 14. Details regarding the process of image processing are provided with reference to FIGS. 6-11. Example training processes are described with reference to FIGS. 12-13.

Accordingly, by enabling the user to provide layout information to a diffusion model, embodiments of the present disclosure enable users to generate images that more accurately reflect a desired layout compared to conventional image generation models. This can reduce the time it takes for users to generate the desired output, as well as guide the model to produce more relevant output. Embodiments give users fine control over the colors and locations of objects in images generated by the diffusion model, while still allowing them to generate multiple versions of an image based on random inputs.

### Network Architecture

In FIGS. 1-5, an apparatus and method for image generation are described. One or more embodiments of the apparatus and method include one or more processors; one or more memories including instructions executable by the one or more processors to: obtain user input that indicates a target color and a semantic label for a region of an image to be generated; generate a noise map including noise biased towards the target color in the region indicated by the user input; and generate the image based on the noise map and the semantic label for the region using a diffusion model, wherein the image includes an object in the region that is described by the semantic label and that has the target color.

In some examples, the diffusion model includes a U-Net architecture. In some examples, the diffusion model includes a text-guided diffusion model. In some examples, the user input includes layout information indicating a plurality of regions of an image canvas, and wherein each of the plurality of regions is associated with a corresponding target color and a corresponding semantic label.

One or more embodiments of the apparatus and method include instruction are further executable to generate an object representation based on the semantic label and the region using a perception model, wherein the image is generated based on an intermediate noise prediction from the diffusion model and the object representation. In some aspects, the perception model comprises a multi-modal encoder.

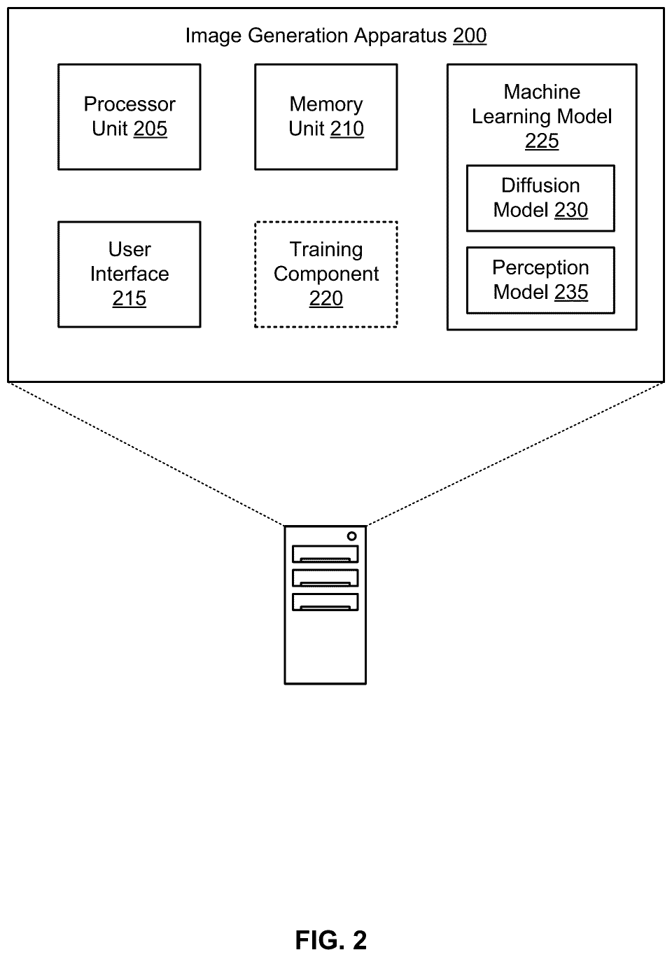

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 2.

As an example shown in FIG. 1, user 100 provides user input such as a text prompt and color layout information (e.g., draw color layout on an image canvas using a brush). In some cases, the user input indicates a target color and a semantic label for a region of an image to be generated. For example, a text prompt is “a hedgehog using a calculator”. An image canvas includes color layout of two objects (e.g., hedgehog and calculator) and their target colors. The image canvas includes an additional color layout of a hedgehog's eye and the corresponding target color of the eye. The user input is transmitted to image generation apparatus 110, e.g., via user device 105 and cloud 115. Image generation apparatus 110 is configured to generate a noise map including noise biased towards the target color in the region indicated by the user input. Image generation apparatus 110 generates the image based on the noise map and the semantic label for the region using a diffusion model. The image includes an object in the region that is described by the semantic label and that has the target color.

In this example, the output image from image generation apparatus 110 includes a scene of two objects that matches the text prompt (semantic labels). In some examples, image generation apparatus 110 determines whether the first object (e.g., the hedgehog) overlaps the second object (e.g., the calculator) based on the text input and color layout. Image generation apparatus 110 generates an output image showing a hedgehog sitting on a calculator based on the text input and the intended color layout. The output image is transmitted to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image generation application. In some examples, the image generation application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a user interface may be represented in code which is sent to the user device and rendered locally by a browser.

Image generation apparatus 110 includes a computer implemented network comprising a user interface, a machine learning model, which includes a diffusion model and perception model. Image generation apparatus 110 also includes a processor unit, a memory unit, and a training component. The training component is used to train the machine learning model. Additionally, image generation apparatus 110 can communicate with database 120 via cloud 115. In some cases, the architecture of the image generation network is also referred to as a network or a network model. Further detail regarding the architecture of image generation apparatus 110 is provided with reference to FIGS. 2-5. Further detail regarding the operation of image generation apparatus 110 is provided with reference to FIGS. 6-11.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses one or more microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by user 100. The term “cloud” is sometimes used to describe data centers available to many users (e.g., user 100) over the Internet. Some large cloud networks have functions distributed over multiple locations from central servers. A server is designated an edge server if the server has a direct or close connection to a user (e.g., user 100). In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with database controller. In other cases, database controller may operate automatically without user interaction.

FIG. 2 shows an example of an image generation apparatus 200 according to aspects of the present disclosure. The example of the image generation apparatus 200 includes processor unit 205, memory unit 210, user interface 215, training component 220, and machine learning model 225. In some embodiments, machine learning model 225 includes diffusion model 230 and perception model 235. Image generation apparatus 200 is an example of, or includes aspects of, the corresponding element described with reference to FIG. 1.

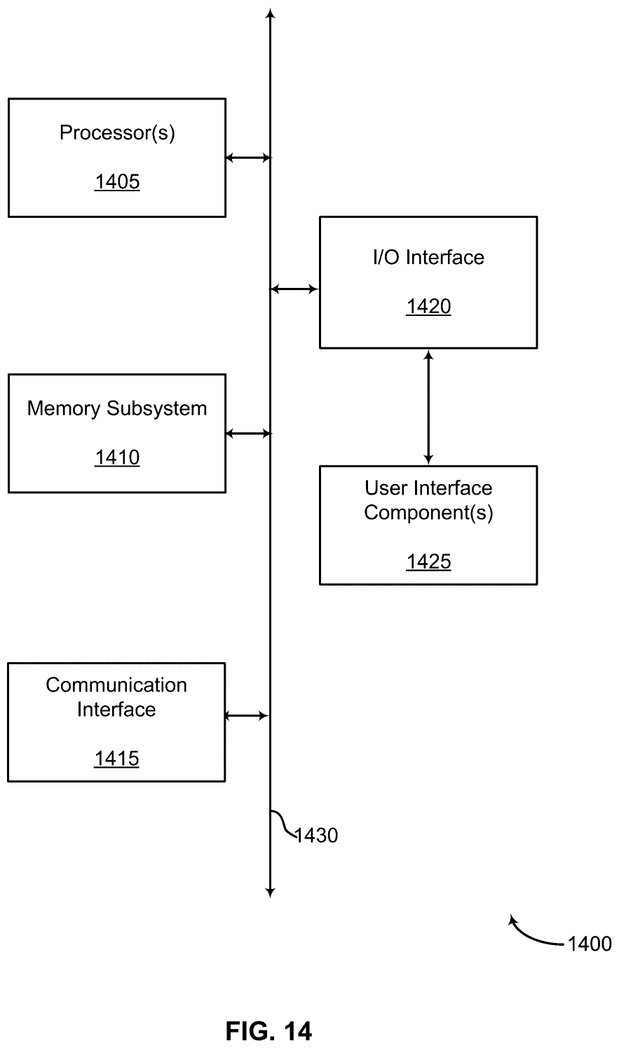

Processor unit 205 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 205 is configured to operate a memory array using a memory controller. In other cases, a memory controller is integrated into the processor. In some cases, processor unit 205 is configured to execute computer-readable instructions stored in a memory to perform various functions. In some embodiments, processor unit 205 includes special-purpose components for modem processing, baseband processing, digital signal processing, or transmission processing. Processor unit 205 is an example of, or includes aspects of, the processor described with reference to FIG. 14.

Memory unit 210 comprises a memory including instructions executable by processor unit 205. Examples of memory unit 210 include random access memory (RAM), read-only memory (ROM), or a hard disk. Examples of memory unit 210 include solid-state memory and a hard disk drive. In some examples, memory unit 210 is used to store computer-readable, computer-executable software including instructions that, when executed, cause a processor to perform various functions described herein. In some cases, memory unit 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory unit 210 store information in the form of a logical state. Memory unit 210 is an example of, or includes aspects of, the memory subsystem described with reference to FIG. 14.

According to some embodiments of the present disclosure, image generation apparatus 200 includes a computer-implemented artificial neural network (ANN) for image generation based on text and color layout guidance. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

According to some embodiments, image generation apparatus 200 includes a computer-implemented convolutional neural network (CNN). CNN is a class of neural network that is commonly used in computer vision or image classification systems. In some cases, a CNN may enable the processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

According to some embodiments, user interface 215 obtains user input that indicates a target color and a semantic label for a region of an image to be generated. In some examples, the user input indicates an additional target color and an additional semantic label for an additional region of an image canvas, and where the image includes an additional object in the additional region that is described by the additional semantic label and that has the additional target color. In some examples, the user input includes a user drawing on an image canvas depicting the target color in the region. In some examples, the user input includes layout information indicating a set of regions of an image canvas, and where each of the set of regions is associated with a corresponding target color and a corresponding semantic label.

According to some embodiments, user interface 215 receives user input via the user interface 215 based on the label input field, the color input field, and a selection of the selection tool, where the layout information is based on the user input.

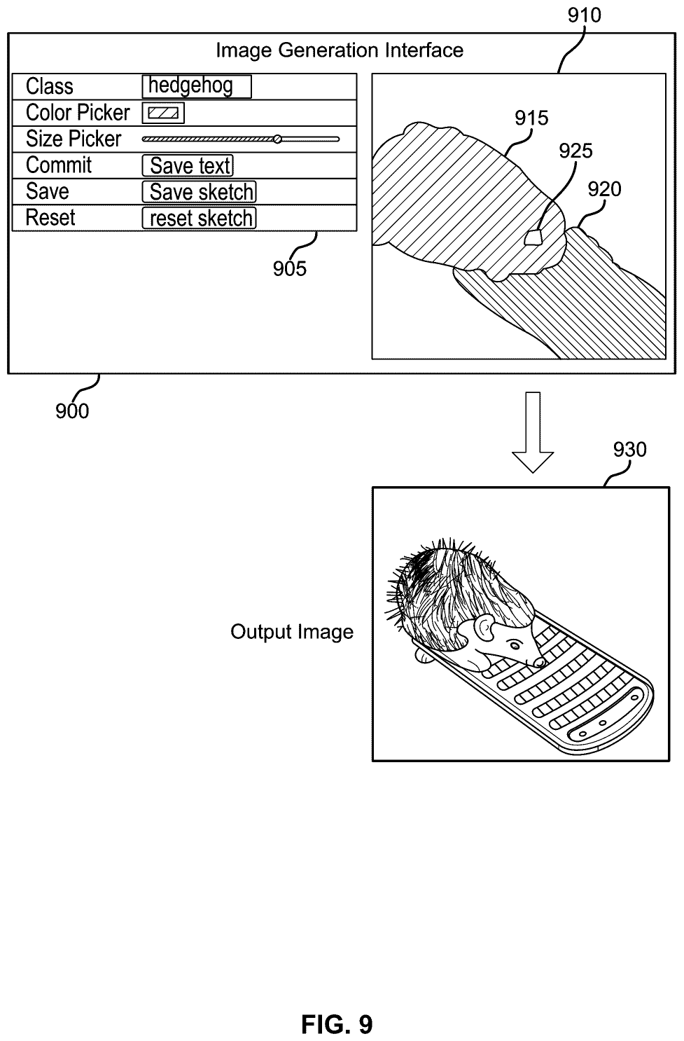

According to some embodiments, user interface 215 comprise obtains user input that indicates a target color and a semantic label for a region of an image to be generated. In some aspects, the user input includes layout information indicating a set of regions of an image canvas, and where each of the set of regions is associated with a corresponding target color and a corresponding semantic label. User interface 215 is an example of, or includes aspects of, the corresponding element described with reference to FIGS. 9 and 14.

In some embodiments, training component 220 trains diffusion model 230 by generating a predicted image based on layout information, computing a loss function based on the predicted image, and updating parameters of diffusion model 230 based on the loss function. In some examples, the loss function comprises a perceptual loss.

According to some embodiments, training component 220 obtains training data including a training image and training layout information that includes semantic information and color information for a region of the training image. In some examples, training component 220 initializes parameters of a diffusion model 230. In some examples, training component 220 computes a loss function based on the training image and the predicted image. In some examples, training component 220 trains diffusion model 230 by updating the parameters of diffusion model 230 based on the loss function. In some examples, training component 220 is part of another apparatus other than image generation apparatus 200. In some examples, training component 220 is included in a separate computing device. In some cases, image generation apparatus 200 communicates with training component 220 in the separate computing device to train machine learning model 225 as described herein. In some examples, training component 220 is implemented as software stored in memory and executable by a processor of the separate computing device, as firmware in the separate computing device, as one or more hardware circuits of the separate computing device, or as a combination thereof.

According to some embodiments, machine learning model 225 displays user interface 215 to a user, where user interface 215 includes a label input field, a color input field, and a selection tool for selecting a region of an image canvas, and where the user input is received via user interface 215.

According to some embodiments, diffusion model 230 generates a noise map including noise biased towards the target color in the region indicated by the user input. In some examples, diffusion model 230 generates the image based on the noise map and the semantic label for the region, where the image includes an object in the region that is described by the semantic label and that has the target color. In some examples, diffusion model 230 begins a reverse diffusion process at an intermediate step of diffusion model 230, where the image is based on an output of the reverse diffusion process.

According to some embodiments, diffusion model 230 generates a predicted image based on the semantic information and the color information. In some examples, diffusion model 230 generates a noise map including a target color in the region of the predicted image, where the predicted image is generated based on the noise map. In some examples, diffusion model 230 generates an image based on the user input. In some examples, diffusion model 230 generates an intermediate noise prediction.

According to some embodiments, diffusion model 230 comprise generates a noise map including noise biased towards the target color in the region indicated by the user input. In some examples, diffusion model 230 generates the image based on the noise map and the semantic label for the region, wherein the image includes an object in the region that is described by the semantic label and that has the target color. In some examples, diffusion model 230 includes a U-Net architecture. In some examples, diffusion model 230 includes a text-guided diffusion model.

According to some embodiments, perception model 235 generates an object representation based on a semantic label and the region, where the predicted image is generated based on the intermediate noise prediction and the object representation. In some examples, perception model 235 includes a multi-modal encoder, and where the object representation is generated using back propagation through the multi-modal encoder.

According to some embodiments, perception model 235 generate an object representation based on the semantic label and the region, wherein the image is generated based on an intermediate noise prediction from diffusion model 230 and the object representation.

The described methods may be implemented or performed by devices that include a general-purpose processor, a digital signal processor (DSP), an application-specific integrated circuit (ASIC), a field programmable gate array (FPGA) or other programmable logic devices, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates the transfer of code or data. A non-transitory storage medium may be any available medium that can be acces sed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

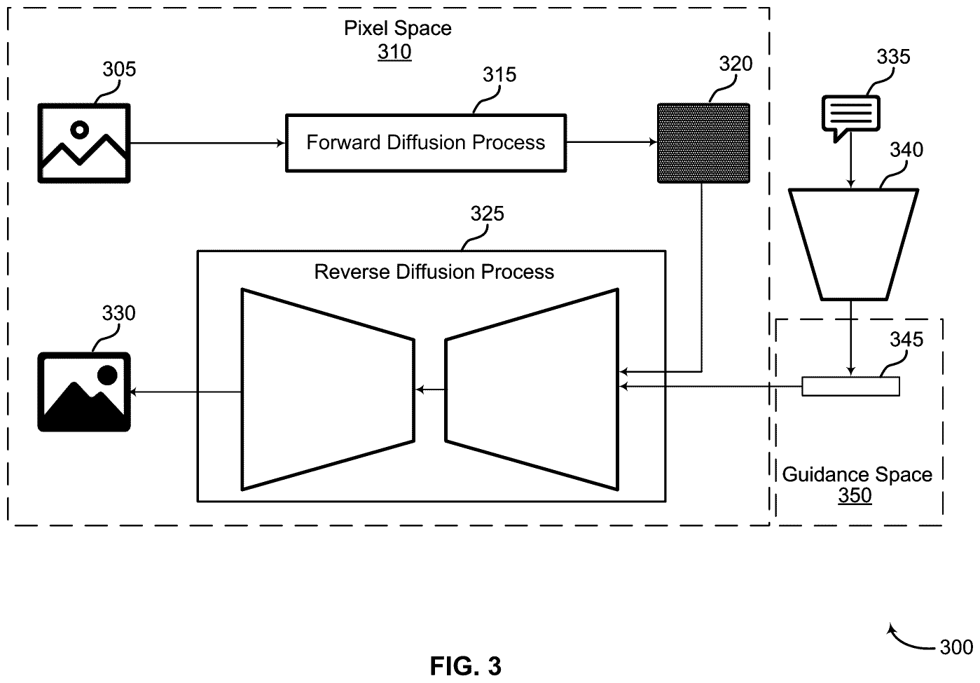

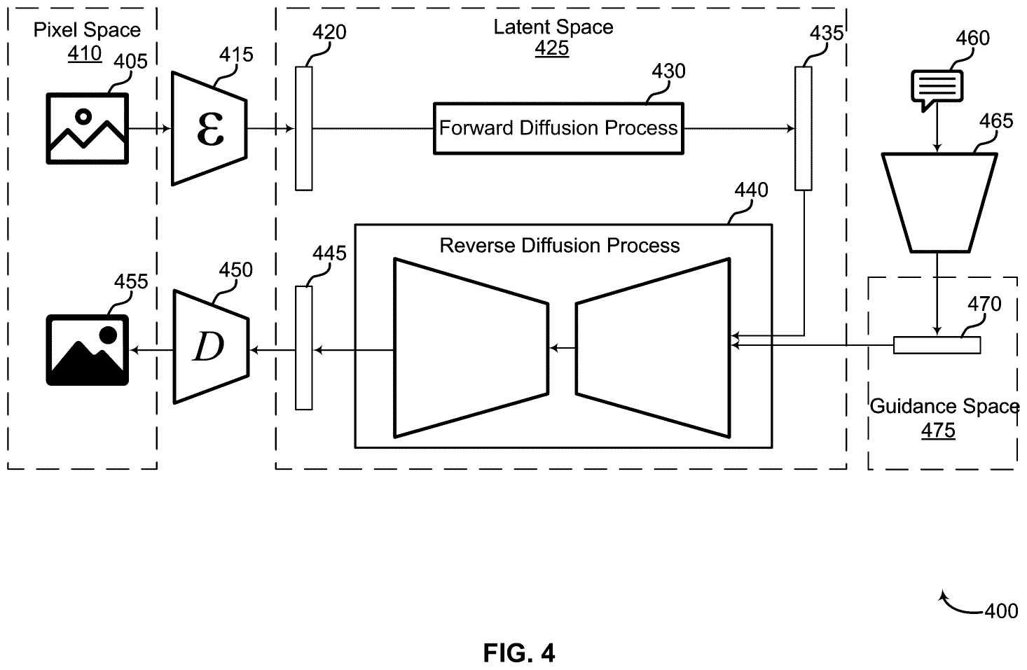

FIG. 3 shows an example of a pixel diffusion model according to aspects of the present disclosure. The example shown includes guided diffusion model 300, original image 305, pixel space 310, noisy images 320, output image 330, text prompt 335, text encoder 340, guidance features 345, and guidance space 350. The example shown includes forward diffusion process 315 and reverse diffusion process 325. Guided diffusion model 300 is an example of, or includes aspects of, the corresponding element described with reference to FIG. 4. Guided diffusion model 300 is an example, or includes aspects of, the diffusion model described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided diffusion model 300 may take an original image 305 in a pixel space 310 as input and apply forward diffusion process 315 to gradually add noise to the original image 305 to obtain noisy images 320 at various noise levels.

Next, a reverse diffusion process 325 (e.g., a U-Net ANN) gradually removes the noise from the noisy images 320 at the various noise levels to obtain an output image 330. In some cases, an output image 330 is created from each of the various noise levels. The output image 330 can be compared to the original image 305 to train the reverse diffusion process 325.

The reverse diffusion process 325 can also be guided based on a text prompt 335, or another guidance prompt, such as an image, a layout, a segmentation map, etc. The text prompt 335 can be encoded using a text encoder 340 (e.g., a multi-modal encoder) to obtain guidance features 345 in guidance space 350. The guidance features 345 can be combined with the noisy images 320 at one or more layers of the reverse diffusion process 325 to ensure that the output image 330 includes content described by the text prompt 335. For example, guidance features 345 can be combined with the noisy features using a cross-attention block within the reverse diffusion process 325.

Original image 305 is an example of, or includes aspects of, the corresponding element described with reference to FIG. 4. Pixel space 310 is an example of, or includes aspects of, the corresponding element described with reference to FIG. 4. Forward diffusion process 315 is an example of, or includes aspects of, the corresponding element described with reference to FIG. 4. Reverse diffusion process 325 is an example of, or includes aspects of, the corresponding element described with reference to FIG. 4. Output image 330 is an example of, or includes aspects of, the corresponding element described with reference to FIGS. 4, 7, 9, and 11.

Text prompt 335 is an example of, or includes aspects of, the corresponding element described with reference to FIG. 4. Text encoder 340 is an example of, or includes aspects of, the corresponding element described with reference to FIG. 4. Guidance features 345 is an example of, or includes aspects of, the corresponding element described with reference to FIG. 4. Guidance space 350 is an example of, or includes aspects of, the corresponding element described with reference to FIG. 4.

FIG. 4 shows an example of a latent diffusion model according to aspects of the present disclosure. The example shown includes guided latent diffusion model 400, original image 405, pixel space 410, image encoder 415, original image features 420, latent space 425, noisy features 435, denoised image features 445, image decoder 450, output image 455, text prompt 460, text encoder 465, guidance features 470, and guidance space 475. The example shown also includes forward diffusion process 430 and reverse diffusion process 440. Guided latent diffusion model 400 is an example of, or includes aspects of, the corresponding element described with reference to FIG. 3. Guided latent diffusion model 400 is an example, or includes aspects of, the diffusion model described with reference to FIG. 2.

Latent diffusion models work by iteratively adding noise to the data during a forward process and then learning to recover the data by denoising the data during a reverse process. For example, during training, guided latent diffusion model 400 may take an original image 405 in a pixel space 410 as input and apply and image encoder 415 to convert original image 405 into original image features 420 in a latent space 425. Then, a forward diffusion process 430 gradually adds noise to the original image features 420 to obtain noisy features 435 (also in latent space 425) at various noise levels.

Next, a reverse diffusion process 440 (e.g., a U-Net ANN) gradually removes the noise from the noisy features 435 at the various noise levels to obtain denoised image features 445 in latent space 425. In some examples, the denoised image features 445 are compared to the original image features 420 at each of the various noise levels, and parameters of the reverse diffusion process 440 of the diffusion model are updated based on the comparison. Finally, an image decoder 450 decodes the denoised image features 445 to obtain an output image 455 in pixel space 410. In some cases, an output image 455 is created at each of the various noise levels. The output image 455 can be compared to the original image 405 to train the reverse diffusion process 440.

In some cases, image encoder 415 and image decoder 450 are pre-trained prior to training the reverse diffusion process 440. In some examples, they are trained jointly, or the image encoder 415 and image decoder 450 and fine-tuned jointly with the reverse diffusion process 440.

The reverse diffusion process 440 can also be guided based on a text prompt 460, or another guidance prompt, such as an image, a layout, a segmentation map, etc. The text prompt 460 can be encoded using a text encoder 465 (e.g., a multi-modal encoder) to obtain guidance features 470 in guidance space 475. The guidance features 470 can be combined with the noisy features 435 at one or more layers of the reverse diffusion process 440 to ensure that the output image 455 includes content described by the text prompt 460. For example, guidance features 470 can be combined with the noisy features 435 using a cross-attention block within the reverse diffusion process 440 in latent space 425.

Original image 405 is an example of, or includes aspects of, the corresponding element described with reference to FIG. 3. Pixel space 410 is an example of, or includes aspects of, the corresponding element described with reference to FIG. 3. Forward diffusion process 430 is an example of, or includes aspects of, the corresponding element described with reference to FIG. 3. Reverse diffusion process 440 is an example of, or includes aspects of, the corresponding element described with reference to FIG. 3. Output image 455 is an example of, or includes aspects of, the corresponding element described with reference to FIGS. 3, 7, 9, and 11.

Text prompt 460 is an example of, or includes aspects of, the corresponding element described with reference to FIG. 3. Text encoder 465 is an example of, or includes aspects of, the corresponding element described with reference to FIG. 3. Guidance features 470 is an example of, or includes aspects of, the corresponding element described with reference to FIG. 3. Guidance space 475 is an example of, or includes aspects of, the corresponding element described with reference to FIG. 3.

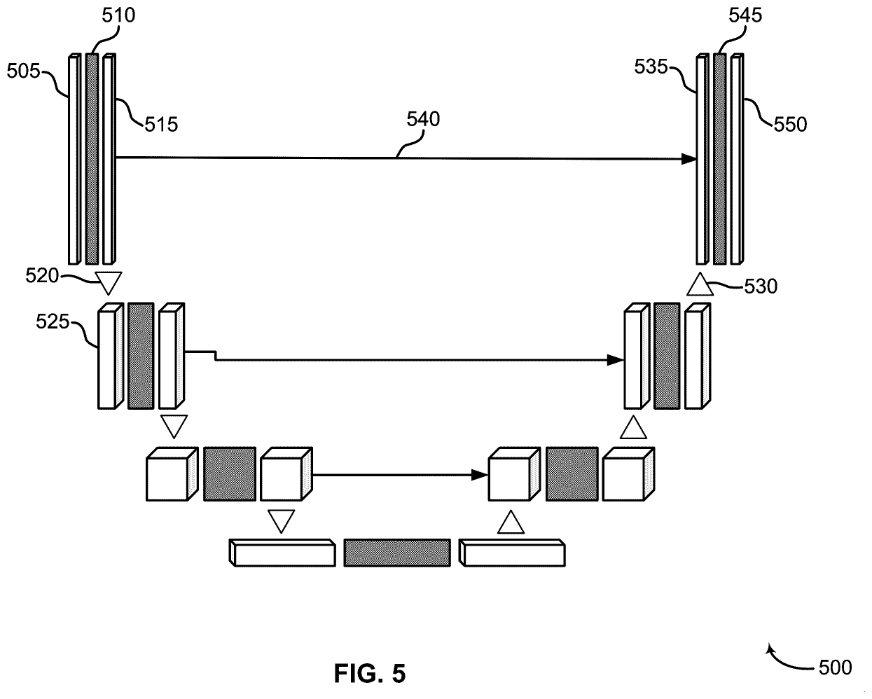

FIG. 5 shows an example of U-Net 500 architecture according to aspects of the present disclosure. The example shown includes U-Net 500, input features 505, initial neural network layer 510, intermediate features 515, down-sampling layer 520, down-sampled features 525, up-sampling process 530, up-sampled features 535, skip connection 540, final neural network layer 545, and output features 550.

The U-Net 500 depicted in FIG. 5 is an example of, or includes aspects of, the architecture used within the reverse diffusion process described with reference to FIGS. 3 and 4.

In some examples, diffusion models are based on a neural network architecture known as a U-Net 500. The U-Net 500 takes input features 505 having an initial resolution and an initial number of channels, and processes the input features 505 using an initial neural network layer 510 (e.g., a convolutional network layer) to produce intermediate features 515. The intermediate features 515 are then down-sampled using a down-sampling layer 520 such that down-sampled features 525 features have a resolution less than the initial resolution and a number of channels greater than the initial number of channels.

This process is repeated multiple times, and then the process is reversed. For example, the down-sampled features 525 are up-sampled using up-sampling process 530 to obtain up-sampled features 535. The up-sampled features 535 can be combined with intermediate features 515 having a same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515.

### Image Generation

In FIGS. 6-11, a method, apparatus, and non-transitory computer readable medium for image generation are described. One or more embodiments of the method, apparatus, and non-transitory computer readable medium include obtaining user input that indicates a target color and a semantic label for a region of an image to be generated; generating a noise map including noise biased towards the target color in the region indicated by the user input; and generating the image based on the noise map and the semantic label for the region using a diffusion model, wherein the image includes an object in the region that is described by the semantic label and that has the target color.

Some examples of the method, apparatus, and non-transitory computer readable medium further include displaying a user interface to a user, wherein the user interface includes a label input field, a color input field, and a selection tool for selecting a region of an image canvas, and wherein the user input is received via the user interface.

In some examples, the user input indicates an additional target color and an additional semantic label for an additional region of an image canvas, and wherein the image includes an additional object in the additional region that is described by the additional semantic label and that has the additional target color.

In some examples, the user input comprises a user drawing on an image canvas depicting the target color in the region. In some examples, the user input includes layout information indicating a plurality of regions of an image canvas, and wherein each of the plurality of regions is associated with a corresponding target color and a corresponding semantic label.

In some examples, the diffusion model is trained by generating a predicted image based on layout information, computing a loss function based on the predicted image, and updating parameters of the diffusion model based on the loss function. In some examples, the loss function comprises a perceptual loss.

Some examples of the method, apparatus, and non-transitory computer readable medium further include beginning a reverse diffusion process at an intermediate step of the diffusion model, wherein the image is based on an output of the reverse diffusion process.

FIG. 6 shows an example of image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the user provides a user command. In some cases, the operations of this step refer to, or may be performed by, a user as described with reference to FIG. 1. As an example, the user command includes a text prompt stating “a hedgehog using a calculator”. The user command also includes an arrangement of one or more objects or entities on an image canvas of the user interface. The user draws a rough layout of the one or more objects on the image canvas. In some examples, the user applies a virtual brush to select a region to represent an object of the one or more objects. In this example, a first virtual brush is associated with the phrase “hedgehog”. A second brush is associated with the phrase “calculator”. A third virtual brush is associated with the phrase “eye”. The user also elects colors for the one or more objects.

At operation 610, the system encodes the user command. In some cases, the operations of this step refer to, or may be performed by, an image generation apparatus as described with reference to FIGS. 1 and 2. According to an embodiment, the image generation apparatus incorporates color guidance and text guidance. For example, the image generation apparatus takes the text prompt, “a hedgehog using a calculator,” and color layout of the one or more objects as input. As used herein, the term “color layout” includes color information of an object and layout information (e.g., position, size, and orientation) of the object to be generated in an output image.

At operation 615, the system generates an output image based on the encoding. In some cases, the operations of this step refer to, or may be performed by, an image generation apparatus as described with reference to FIGS. 1 and 2. In the above example, the output image shows that a hedgehog is disposed on a calculator. This output image also shows the orientation and position of the hedgehog is consistent with the intended color layout.

At operation 620, the system displays the output image to the user. In some cases, the operations of this step refer to, or may be performed by, an image generation apparatus as described with reference to FIGS. 1 and 2. In some examples, image generation apparatus displays the output image to the user via the user interface.

FIG. 7 shows an example of text to image generation according to aspects of the present disclosure. The example shown includes image 700, region of interest 705, output image 710, and text 715. Output image 710 is an example of, or includes aspects of, the corresponding element described with reference to FIGS. 3, 4, 9, and 11. As an example shown in FIG. 7, image 700 includes region of interest 705 that is to be erased and filled in with other content. Region of interest 705 is generated based on text guidance (e.g., a text prompt). In the example shown in FIG. 7, text 715 states “a vase of flowers”. Machine learning model 225 as shown in FIG. 2 performs text-conditional image inpainting using a diffusion model (e.g., GLIDE). Region of interest 705 is erased, and machine learning model 225 fills the region of interest 705 based on text 715. Machine learning model 225 matches the style and lighting of the surrounding context of the image 700 to produce a realistic completion. Output image 710 shows a scene of objects that is consistent with the text guidance (text 715).

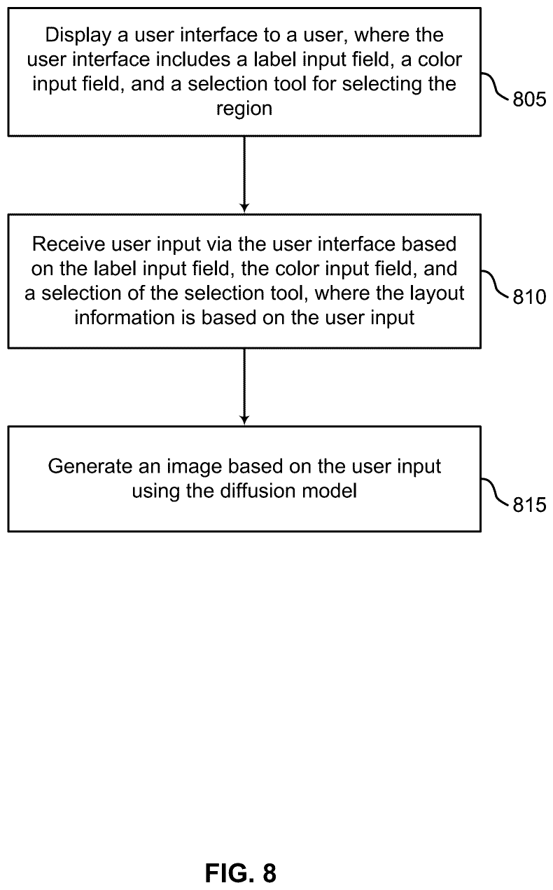

FIG. 8 shows an example of a method for operating a user interface according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system displays a user interface to a user, where the user interface includes a label input field, a color input field, and a selection tool for selecting the region. In some cases, the operations of this step refer to, or may be performed by, a machine learning model as described with reference to FIG. 2. User interface is an example of, or includes aspects of, the corresponding element described with reference to FIGS. 2, 9, and 14. For example, a user can use the selection tool (e.g., a virtual brush) to draw a rough layout of one or more objects on an image canvas of the user interface.

At operation 810, the system receives user input via the user interface based on the label input field, the color input field, and a selection of the selection tool, where the layout information is based on the user input. In some cases, the operations of this step refer to, or may be performed by, a user interface as described with reference to FIGS. 2 and 9. For example, the user selects a first region using the selection tool (e.g., the virtual brush), indicates the first region as hedgehog, and designates a color as yellow. The user further selects a second region and a third region. The user enters a corresponding class label into the label input field and a corresponding color into the color input field. The machine learning model receives the user input as guides (text guide and color layout guide).

At operation 815, the system generates an image based on the user input using the diffusion model. In some cases, the operations of this step refer to, or may be performed by, a diffusion model as described with reference to FIG. 2. For example, the diffusion model generates a noise map including noise biased towards the target color in the region indicated by the user input. The diffusion model generates the image based on the noise map and the semantic label for the region, where the image includes an object in the region that is described by the semantic label and that has the target color. The combination of using a color layout guidance and text guidance enables precise control of the layout of a set of objects in the generated image. According to an embodiment, the user interface includes a virtual brush that represents color and text pairing.

FIG. 9 shows an example of a user interface according to aspects of the present disclosure. The example shown includes user interface 900, user input 905, image canvas 910, first selection region 915, second selection region 920, third selection region 925, and output image 930. FIG. 9 shows an example of text and color-guided layout control interface. User interface 900 includes receiving user input 905 (e.g., text information such as semantic label or class). User input 905 includes semantic label of an entity (e.g., class), color input (e.g., color picker), and size of a selection tool (e.g., size picker). User interface 900 includes editing image canvas 910 where users can draw or indicate color layout of one or more objects. The one or more objects are included in output image 930 to be generated.

According to an embodiment of the present disclosure, user interface 900 enables a user to control the object layout in an image to be generated (e.g., output image 930). User interface 900 receives a command from a user. For example, the user inputs a text prompt and a rough color layout of entities (e.g., objects) in a 2D canvas (e.g., image canvas 910). User interface 900 receives user commands where the user commands include text prompt in an image canvas. The user selects a region on the image canvas using a virtual brush associated with the phrase “hedgehog”. The user also inputs an intended color of the entity “hedgehog”. Then, the user draws a rough layout of this entity.

In some examples, image canvas 910 includes first selection region 915, second selection region 920, and third selection region 925. First selection region 915 corresponds to entity “hedgehog”. Second selection region 920 corresponds to entity “calculator”. Third selection region 925 corresponds to entity “eye” of the hedgehog, which may or may not be recited in the text prompt. Embodiments of the present disclosure are not limited to the three selection regions mentioned herein.

The user repeats this process for one or more additional entities as the user desires to include in output image 930. As an example, the user also desires to have a “calculator” and an “eye” to be generated in output image 930, thereby inputs second selection region 920 and third selection region 925 with corresponding user input 905. Output image 930 shows a hedgehog next to a calculator. The scene depicted in output image 930 is consistent with the color layout and object relations in the image canvas. The scene depicted in output image 930 is also consistent with the text prompt.

No additional training or tuning of the diffusion model is involved, and thus, embodiments of the present disclosure are not dependent on costly training process of diffusion models. User interface 900 is an example of, or includes aspects of, the corresponding element described with reference to FIG. 2. Output image 930 is an example of, or includes aspects of, the corresponding element described with reference to FIGS. 3, 4, 7, and 11.

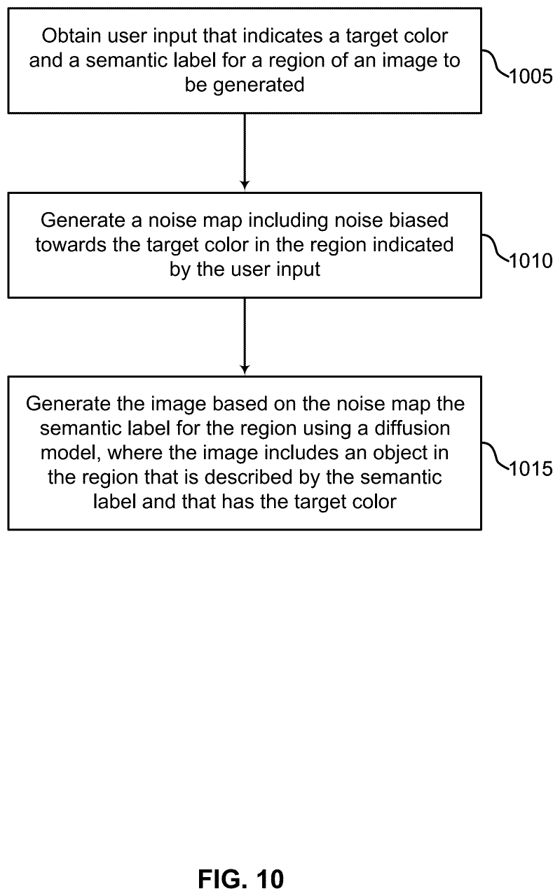

FIG. 10 shows an example of a method for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains user input that indicates a target color and a semantic label for a region of an image to be generated. In some cases, the operations of this step refer to, or may be performed by, a user interface as described with reference to FIGS. 2 and 9. Detail regarding collecting user input via user interface is described in FIGS. 8 and 9. In some embodiments, the diffusion model generates an image based on the user input (e.g., text and color layout) as guidance.

At operation 1010, the system generates a noise map including noise biased towards the target color in the region indicated by the user input. In some cases, the operations of this step refer to, or may be performed by, a diffusion model as described with reference to FIG. 2.

According to an embodiment, the diffusion model incorporates color guidance and text guidance. A color layout contains some noise. To incorporate the color layout, the diffusion model begins the denoising process from a noisy version of the color layout instead of starting from a complete white noise. A noisy version of the rough color layout looks similar to the noise version of the photographic output image.

Next, text guidance is incorporated to machine learning model 225 as shown in FIG. 2 by using the classifier-guidance in a localized way. For example, at each denoising step of the diffusion process, the machine learning model guides the denoising step such that the user-drawn region is more likely to be perceived as a text guidance using pre-trained perception model 235.

In some embodiments, pre-trained perception model 235 includes a CLIP model. In some cases, at each denoising step, from the intermediate output image of the diffusion model, machine learning model 225 extracts each entity region using the selection region or mask drawn by the user. In some cases, the selection region is referred to as a mask region. The perception model computes how much the mask region is perceived by perception model 235 (e.g., CLIP) as the associated text prompt. Through backpropagation, machine learning model 225 computes gradient to maximize the perception model's perception of the region as the target text prompt. Perception model 235 applies the gradient to the intermediate output of the diffusion model. According to some embodiments, machine learning model 225 introduces the noise at an intermediate step in a denoising process. For example, if the denoising process includes 1000 steps to generate an output image, the noise can be introduced to an intermediate step from the 400th step to 1000th step. That is, a reverse diffusion process begins at an intermediate step i.e., the 400th step. Thus, by introducing noise at a portion of the intermediate steps, in this example, machine learning model 225 is 40% more efficient compared to introducing noise at every intermediate step. However, embodiments of the present disclosure are not limited to introducing noise at 400th step of a denoising process. Noise may be introduced to any intermediate step of the denoising process of the machine learning model.

At operation 1015, the system generates the image based on the noise map and the semantic label for the region using a diffusion model, where the image includes an object in the region that is described by the semantic label and that has the target color. In some cases, the operations of this step refer to, or may be performed by, a diffusion model as described with reference to FIG. 2. The generated image is displayed to the user.

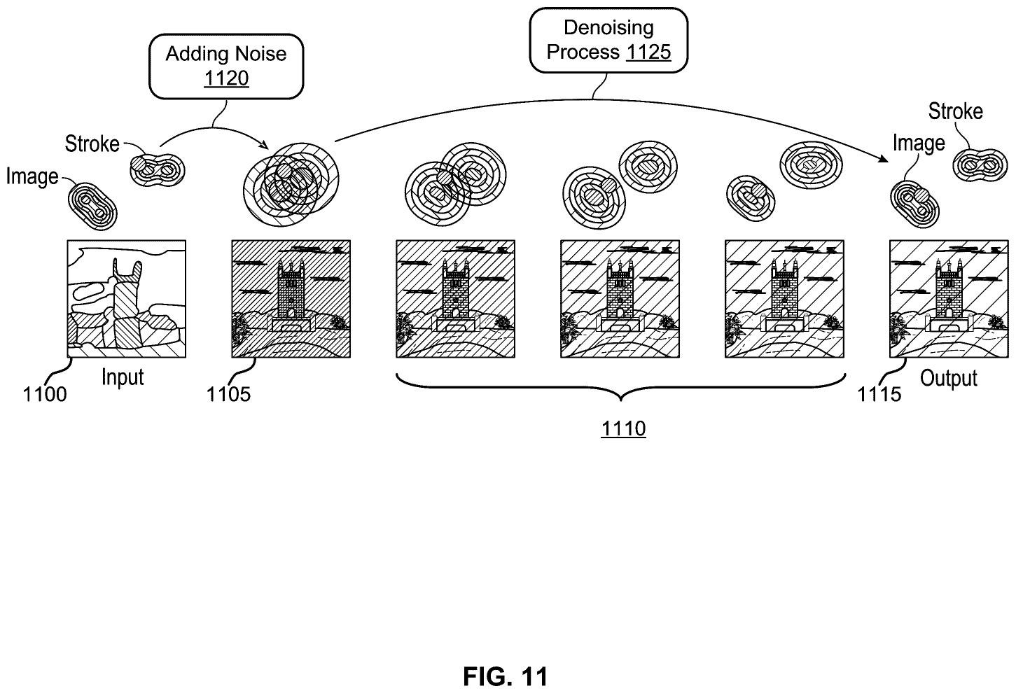

FIG. 11 shows an example of image generation based on color-guided layout according to aspects of the present disclosure. The example shown includes input stroke painting 1100, noised image 1105, denoised image 1110, output image 1115, adding noise 1120, and denoising process 1125. Output image 1115 is an example of, or includes aspects of, the corresponding element described with reference to FIGS. 3, 4, 7, and 9.

The machine learning model applies image synthesis and editing method, e.g., stochastic differential editing (SDEdit), based on a diffusion model generative prior, which synthesizes realistic images by iteratively denoising through a stochastic differential equation (SDE). Given an input stroke painting 1100 with user guide in a form of manipulating RGB pixels, SDEdit adds noise (via adding noise 1120) to the input stroke painting 1100, then subsequently denoises the resulting image through the SDE (via denoising process 1125) prior to increase its realism.

An example of FIG. 11 shows synthesizing images from strokes with SDEdit. The shaded dots illustrate the editing process. Shaded “image” contour plots and shaded “stroke” contour plots represent the distributions of images and stroke paintings, respectively. Given an input stroke painting 1100, the machine learning model first perturbs (via adding noise 1120) input stroke painting 1100 with Gaussian noise and progressively removes the noise (via denoising process 1125) by simulating the reverse stochastic differential equation (SDE). This process gradually projects an unrealistic stroke painting (e.g., input stroke painting 1100) to the manifold of natural images (e.g., output image 1115).

### Training and Evaluation

In FIGS. 12-13, a method, apparatus, and non-transitory computer readable medium for image generation are described. One or more embodiments of the method, apparatus, and non-transitory computer readable medium include obtaining training data including a training image and training layout information that includes semantic information and color information for a region of the training image; initializing parameters of a diffusion model; generating a predicted image using the diffusion model based on the semantic information and the color information; computing a loss function based on the training image and the predicted image; and training the diffusion model by updating the parameters of the diffusion model based on the loss function.

In some examples, the loss function comprises a perceptual loss. Some examples of the method, apparatus, and non-transitory computer readable medium further include generating a noise map including a target color in the region of the predicted image, wherein the predicted image is generated based on the noise map.

Some examples of the method, apparatus, and non-transitory computer readable medium further include displaying a user interface to a user, wherein the user interface includes a label input field, a color input field, and a selection tool for selecting the region. Some examples further include receiving user input via the user interface based on the label input field, the color input field, and a selection of the selection tool, wherein the layout information is based on the user input. Some examples further include generating an image based on the user input using the diffusion model.

Some examples of the method, apparatus, and non-transitory computer readable medium further include generating an intermediate noise prediction using the diffusion model. Some examples further include generating an object representation based on a semantic label and the region using a perception model, wherein the predicted image is generated based on the intermediate noise prediction and the object representation.

In some examples, the perception model comprises a multi-modal encoder, and where the object representation is generated using back propagation through the multi-modal encoder.

FIG. 12 shows an example of a method for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like. In some cases, the operations of this step refer to, or may be performed by, a training component as described with reference to FIG. 2.

At operation 1210, the system adds noise to a training image using a forward diffusion process in N stages. In some cases, the forward diffusion process is a fixed process where Gaussian noise is successively added to an image. In latent diffusion models, the Gaussian noise may be successively added to features in a latent space. In some cases, the operations of this step refer to, or may be performed by, a training component as described with reference to FIG. 2.

At operation 1215, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process. In some cases, the operations of this step refer to, or may be performed by, a training component as described with reference to FIG. 2.

At operation 1220, the system compares the predicted image (or image features) at stage n−1 to an actual image (or image features), such as the image at stage n−1 or the original input image. For example, given observed data x, the diffusion model may be trained to minimize the variational upper bound of the negative log-likelihood −logp_{θ}(x) of the training data. In some cases, the operations of this step refer to, or may be performed by, a training component as described with reference to FIG. 2.

At operation 1225, the system updates parameters of the model based on the comparison. For example, parameters of a U-Net may be updated using gradient descent. Time-dependent parameters of the Gaussian transitions can also be learned. In some cases, the operations of this step refer to, or may be performed by, a training component as described with reference to FIG. 2.

FIG. 13 shows an example of a method for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system obtains training data including a training image and training layout information that includes semantic information and color information for a region of the training image. In some cases, the operations of this step refer to, or may be performed by, a training component as described with reference to FIG. 2. In some embodiments, the training image is a real image. In some examples, the training image is used as positive examples during training. Layout information includes semantic information, such as class label of an object, and color information in the region of the training image. In some examples, the layout information is used as negative examples during training.

At operation 1310, the system initializes parameters of a diffusion model. In some cases, the operations of this step refer to, or may be performed by, a training component as described with reference to FIG. 2. In some cases, initializing parameters of a diffusion model includes specifying the architecture of the diffusion model and establishing initial values for model parameters. In some cases, the initialization includes defining hyper-parameters such as the number of layers, the resolution and channels of each layer block, the location of skip connections, etc.

At operation 1315, the system generates a predicted image using the diffusion model based on the semantic information and the color information. In some cases, the operations of this step refer to, or may be performed by, a diffusion model as described with reference to FIG. 2. In some cases, the predicted image (or generated image) includes the semantic information and the color information of the training layout information. The predicted image is compared to the training image during training.

At operation 1320, the system computes a loss function based on the training image and the predicted image. In some cases, the operations of this step refer to, or may be performed by, a training component as described with reference to FIG. 2. In some cases, the loss function is an L2 loss. L2 loss is used to minimize the error which is the sum of all squared difference between the values from the training data and the values from the predicted image. In some cases, the training component encourages a high dot product if the generated image is paired with the training data, or a low dot product if the generated image and the training data correspond to different pairs. In some examples, the loss function includes a perceptual loss. Perceptual loss is used to compare two different images that look similar with a shift by one pixel.

The term loss function refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly and a new set of predictions are made during the next iteration.

At operation 1325, the system trains the diffusion model by updating the parameters of the diffusion model based on the loss function. In some cases, the operations of this step refer to, or may be performed by, a training component as described with reference to FIG. 2. In some cases, the training component continues to train the diffusion model until a loss is below a threshold value. When a loss is zero, the prediction of diffusion model matches the real data. On the contrary, if a loss is greater than zero, the prediction of the diffusion model does not match the real data.

FIG. 14 shows an example of a computing device 1400 for image generation according to aspects of the present disclosure. The example shown includes computing device 1400, processor(s) 1405, memory subsystem 1410, communication interface 1415, I/O interface 1420, user interface component(s) 1425, and channel 1430.

In some embodiments, computing device 1400 is an example of, or includes aspects of, the image editing apparatus as described with reference to FIGS. 1-2. In some embodiments, computing device 1400 includes one or more processors 1405 that can execute instructions stored in memory subsystem 1410 to obtain user input that indicates a target color and a semantic label for a region of an image to be generated; generate a noise map including noise biased towards the target color in the region indicated by the user input; and generating the image based on the noise map and the semantic label for the region using a diffusion model, wherein the image includes an object in the region that is described by the semantic label and that has the target color.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-controlled device interfaced with a user interface directly or through the I/O controller), or a combination thereof. In some cases, user interface component(s) 1425 include a GUI.

Performance of apparatus, systems and methods of the present disclosure have been evaluated, and results indicate embodiments of the present disclosure have obtained increased performance over existing technology. Example experiments demonstrate that image generation apparatus 200 of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining user input that indicates a target color and a semantic label for a region of an image to be generated;
generating a noise map including noise biased towards the target color in the region indicated by the user input; and
generating the image based on the noise map and the semantic label for the region using a diffusion model, wherein the image includes an object in the region that is described by the semantic label and that has the target color.

2. The method of claim 1, further comprising:
displaying a user interface to a user, wherein the user interface includes a label input field, a color input field, and a selection tool for selecting a region of an image canvas, and wherein the user input is received via the user interface.

3. The method of claim 1, wherein:
the user input indicates an additional target color and an additional semantic label for an additional region of an image canvas, and wherein the image includes an additional object in the additional region that is described by the additional semantic label and that has the additional target color.

4. The method of claim 1, wherein:
the user input comprises a user drawing on an image canvas depicting the target color in the region.

5. The method of claim 1, wherein:
the user input includes layout information indicating a plurality of regions of an image canvas, and wherein each of the plurality of regions is associated with a corresponding target color and a corresponding semantic label.

6. The method of claim 1, wherein:
the diffusion model is trained by generating a predicted image based on layout information, computing a loss function based on the predicted image, and updating parameters of the diffusion model based on the loss function.

7. The method of claim 6, wherein:
the loss function comprises a perceptual loss.

8. The method of claim 1, further comprising:
beginning a reverse diffusion process at an intermediate step of the diffusion model, wherein the image is based on an output of the reverse diffusion process.

9. A method comprising:
obtaining training data including a training image and training layout information that includes semantic information and color information for a region of the training image;
initializing parameters of a diffusion model; and
training the diffusion model to generate images corresponding to the training layout information.

10. The method of claim 9, wherein the training further comprises:
generating a predicted image using the diffusion model based on the semantic information and the color information;
computing a perceptual loss function based on the training image and the predicted image; and
updating parameters of the diffusion model based on the perceptual loss.

11. The method of claim 9, further comprising:
generating a noise map including a target color in the region; and
generating a predicted image based on the noise map using the diffusion model.

12. The method of claim 9, further comprising:
displaying a user interface to a user, wherein the user interface includes a label input field, a color input field, and a selection tool for selecting the region;
receiving user input via the user interface based on the label input field, the color input field, and a selection of the selection tool, wherein layout information is based on the user input; and
generating an image based on the user input using the diffusion model.

13. The method of claim 9, further comprising:
generating an intermediate noise prediction using the diffusion model; and
generating an object representation based on a semantic label and the region using a perception model, wherein the predicted image is generated based on the intermediate noise prediction and the object representation.

14. The method of claim 13, wherein:
the perception model comprises a multi-modal encoder, and wherein the object representation is generated using back propagation through the multi-modal encoder.

15. An apparatus comprising:
one or more processors; and
one or more memories including instructions executable by the one or more processors to:
obtain user input that indicates a target color and a semantic label for a region of an image to be generated;
generate a noise map including noise biased towards the target color in the region indicated by the user input; and
generate the image based on the noise map and the semantic label for the region using a diffusion model, wherein the image includes an object in the region that is described by the semantic label and that has the target color.

16. The apparatus of claim 15, wherein:
the diffusion model comprises a U-Net architecture.

17. The apparatus of claim 15, wherein:
the diffusion model comprises a text-guided diffusion model.

18. The apparatus of claim 15, wherein:
the user input includes layout information indicating a plurality of regions of an image canvas, and wherein each of the plurality of regions is associated with a corresponding target color and a corresponding semantic label.

19. The apparatus of claim 15, wherein the instructions are further executable to:
generate an object representation based on the semantic label and the region using a perception model, wherein the image is generated based on an intermediate noise prediction from the diffusion model and the object representation.

20. The apparatus of claim 19, wherein:
the perception model comprises a multi-modal encoder.
